(19) United States
(12) Patent Application Publication
(10) Pub. No.: US 2010/0139101 A1
(43) Pub. Date: Jun. 10, 2010

(54) CHISELS

(76) Inventor: Robert Cooper, St. Saviours (GB)

Correspondence Address: BARNES & THORNBURG LLP, P.O. BOX 2786, CHICAGO, IL, 60690-2786, US

(21) Appl. No.: 12/307,037

(22) PCT Filed: Jun. 27, 2007
(86) PCT No.: PCT/GB07/50365

§ 371 Date: Dec. 30, 2008

(30) Foreign Application Priority Data
Jun. 30, 2006 (GB) 0612972.0
Nov. 27, 2006 (GB) 0623562.6

(51) Int. Cl. B25D 3/00; B25G 3/38; B25G 1/08; A45F 5/14

(52) U.S. Cl. 30/153; 30/167; 30/342; 224/660

(57) ABSTRACT

A safety chisel (100) has handle parts (101) and (102), each pivotally connected to a chisel blade (105) by pins (104), to adjust the chisel readily from an open position (FIG. 11) to a closed position (FIG. 12). Grooves (107) in the handle parts (101, 102) form a cavity (109) to house the chisel blade (105) safely when the chisel (100) is closed. Impact forces are applied to flat tops of the handle parts (101, 102), which have lower, internal abutment faces 108 to transmit impact forces to the chisel blade (105).

The present invention relates to chisels.

The chisel is a well-known tool comprising an elongate shaft that has a sharp cutting edge at a tip thereof and is secured in a handle that is designed to be struck, typically by a mallet or hammer, thereby to transfer a force from the striking instrument to the sharp cutting edge of the blade, in order to cut into a workpiece. A chisel blade is often ground only at one side to form the cutting edge, thereby to facilitate repeated re-sharpening. However, sometimes chisels have cutting edges that are angled at both sides. Chisels may have wooden handles designed to be struck by wooden mallets or, very often these days, handles of tough plastics materials designed to be struck by metal hammers. Chisels can also be used by applying a force to the handle by hand but, in general, they are designed to be struck.

The cutting edge of a chisel is ideally maintained in a very sharp condition. Thus, there is a requirement for the sharp edge to be protected. One reason for this is that it may otherwise injure someone accidentally. Another reason is that the edge could easily become blunted by impact with a hard surface or object. Therefore, it is common for a chisel to be provided these days with a small plastic cover that fits onto the sharp tip of the blade as a friction fit, thereby to protect the sharp cutting edge. This is all very well until the small plastic cover becomes lost, as it soon does in practice. The sharp cutting edge of the chisel is then left exposed, such that it may either cause injury or suffer damage.

It is known to provide chisels in protective boxes, either individually or in sets. However, such boxes soon become lost and, once again, chisel tips become exposed either to cause injury or become damaged.

It is known to provide chisels with removal blades that can be stored in the chisel handle (e.g. CH 684 835 and U.S. Pat. No. 5,953,820). However, it is a time-consuming exercise to remove and replace blades and the metal shaft of the chisel remains in place. Thus, the length of the chisel remains substantially unchanged and the metal shaft itself may either cause injury or become damaged.

Preferred embodiments of the present invention aim to provide chisels that may be improved in the foregoing respects.

According to one aspect of the present invention, there is provided a chisel comprising:

a handle;

an elongate shaft having a inner end and an outer end with a cutting edge at said outer end; and

mounting means for mounting the shaft on the handle:

wherein:

the handle has a cavity therein; and

the mounting means is arranged to mount the shaft in the handle in an adjustable manner such that, in a first, working position, the shaft extends from the handle and receives impact forces that are applied to the handle in use of the chisel; and, in a second, storage position, the shaft is stored within the cavity in the handle such that said cutting edge is not exposed.

Preferably, said shaft is of metal.

Preferably, said cutting edge is formed integrally with said shaft, at said outer end thereof.

Said handle may comprise wood, metal or plastics material.

Preferably, said mounting means comprises a shaft holder at an open end of said cavity, said shaft holder having a slot that allows passage of said shaft therethrough and engagement means adapted to engage said shaft when in said first, working position, thereby to inhibit rotation of said shaft about its longitudinal axis.

Preferably, said shaft has shoulders formed towards said inner end thereof and said engagement means on said shaft holder comprises recesses adapted to receive said shoulders.

Preferably, said cutting edge is housed within said shaft holder when said shaft is in its second, storage position.

Preferably, said mounting means comprises locking means provided within said cavity and arranged to lock said shaft in said first and second positions.

Preferably, said locking means comprises at least one rotatable element carried on said shaft and arranged to be actuated by rotation of said handle with respect to said shaft.

Preferably, said locking means comprises at least one nut member that screw-threadedly engages said shaft and is entrained by said handle for rotation with said handle.

Preferably, said locking means comprises a resilient member that is arranged to be compressed, thereby to engage the walls of said cavity to inhibit longitudinal movement of said shaft.

In an alternative embodiment, said handle may comprise first and second handle parts, each of which is pivotally mounted on said shaft for movement between open and closed positions such that, when said handle parts are in said open position, said shaft is in said working position and said handle parts cooperate to transmit impact forces to the shaft in use of the chisel and, when said handle parts are in said closed position, said shaft is in said storage position and said handle parts cooperate to define said cavity within which said shaft is stored.

Said handle parts may be mounted on said shaft by rivets or pins.

Said handle parts may define abutment faces which, when said handle parts are in said open position, abut an opposing face of said shaft, thereby to transmit impact forces to said shaft in use of the chisel.

A chisel as above may further comprise retaining means for retaining said handle parts in said open and closed positions.

A chisel as above may further comprise location means for positively locating said handle parts in predetermined juxtaposition when in said open position.

The invention extends to a tool belt attachment comprising at least one pocket containing a chisel according to any of the preceding aspects of the invention. There may be provided a plurality of pockets, each containing a respective chisel.

For a better understanding of the invention, and to show how embodiments of the same may be carried into effect, reference will now be made, by way of example, to the accompanying diagrammatic drawings, in which:

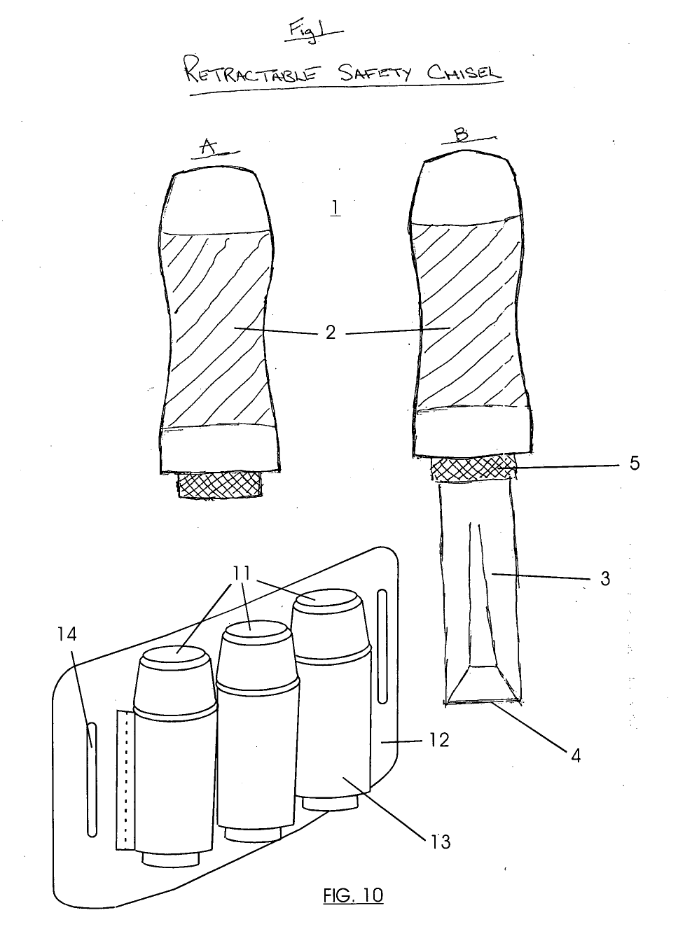

FIG. 1 is a side view of one example of a chisel comprising one embodiment of the invention, with a blade of the chisel being retracted in View A and in an operational position in View B;

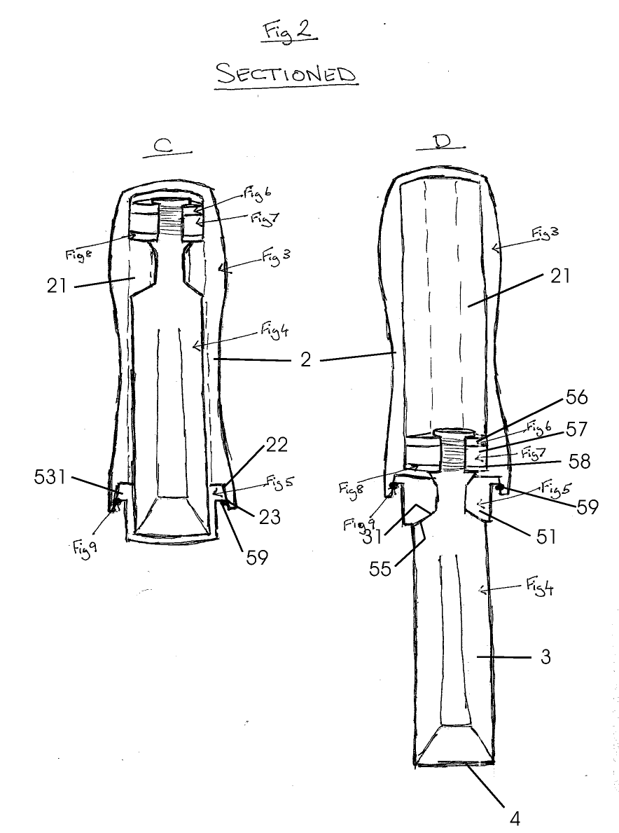

FIG. 2 is a longitudinal sectional view that corresponds to FIG. 1, with the blade of the chisel being retracted in View C and in an operational position in View D;

FIG. 3 is a side view of a handle of the chisel of FIGS. 1 and 2; with a cross-sectional detail view taken on line 1A-1A;

FIG. 4 is a side view of a blade of the chisel of FIGS. 1 and 2; with a cross-sectional detail view taken on line 2B-2B;

FIG. 5 shows a blade holder of the chisel in front view, side view and rear view;

FIG. 6 is a perspective view of a metal nut of the chisel;

FIG. 7 is a perspective view of a rubber washer of the chisel;

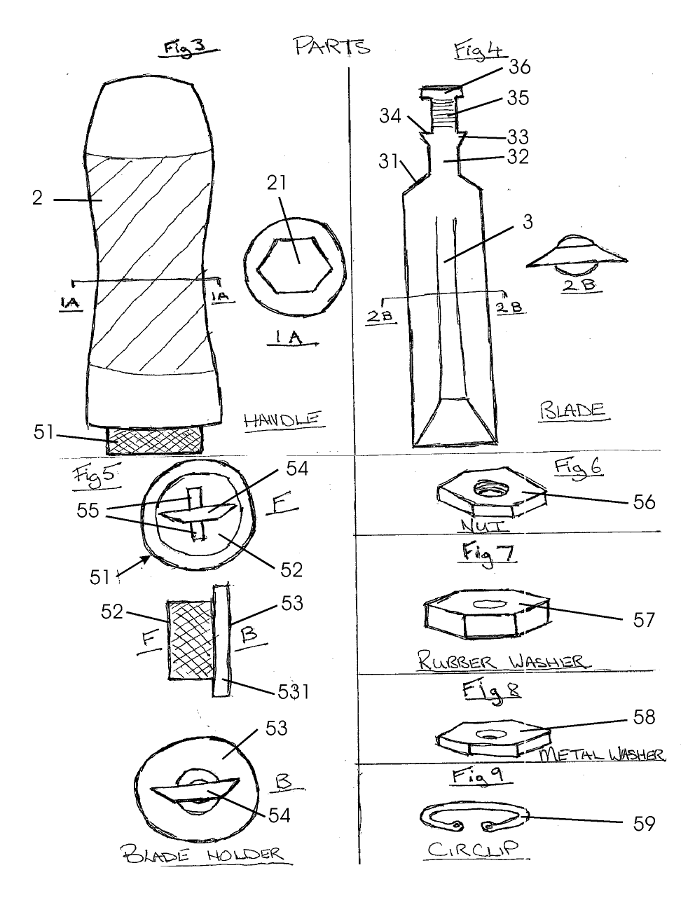

FIG. 8 is a perspective view of a metal washer of the chisel; and

FIG. 9 is a perspective view of a metal circlip of the chisel;

FIG. 10 is a perspective view of a tool belt attachment holding a plurality of chisels;

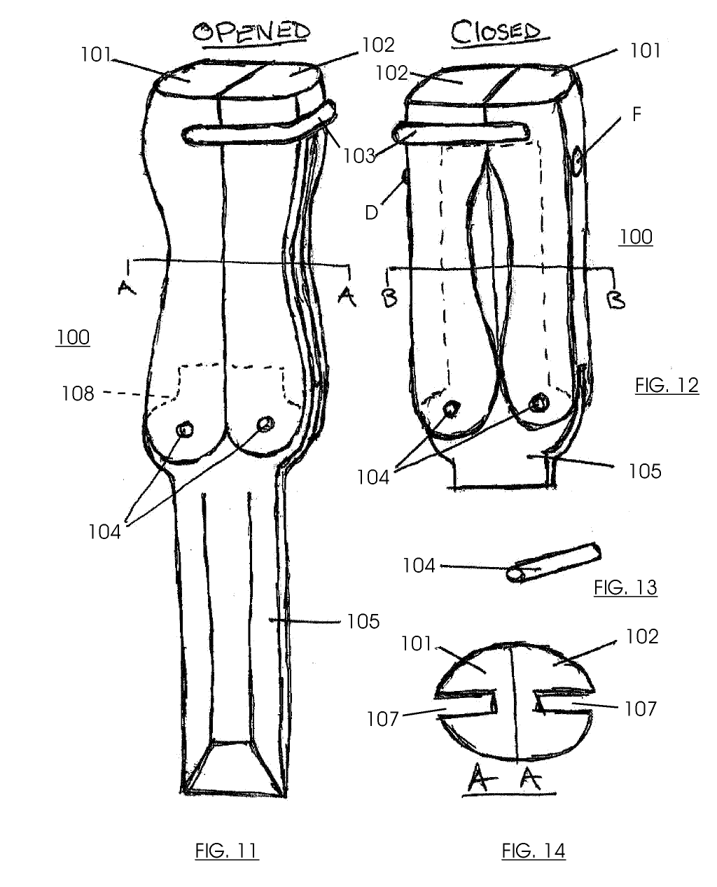

FIG. 11 is a perspective view of a second safety chisel in a working position;

FIG. 12 is a perspective view of the second safety chisel in a storage position;

FIG. 13 shows a rivet or pin of the second safety chisel;

FIG. 14 is a sectional view on the line A-A of FIG. 11;

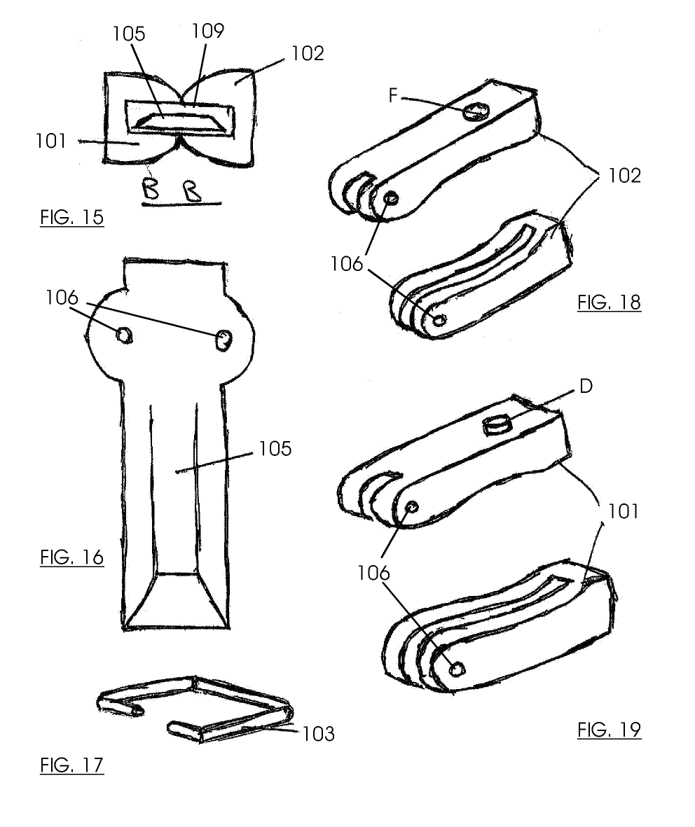

FIG. 15 is a sectional view on the line B-B of FIG. 12; and

FIGS. 16 to 19 show respective parts of the second safety chisel.

In the figures, like references denote like or corresponding parts.

The safety chisel 1 illustrated in FIGS. 1 to 9 comprises a handle 2, a shaft 3 having a cutting edge 4 at its tip and a shaft mounting assembly 5, by means of which the shaft 3 is mounted in the handle 2. In the illustrated example, the shaft 3 is afforded by an elongate blade, at the tip of which the cutting edge 4 is formed integrally. This is a common configuration for a chisel. However, it is known also to provide alternative configurations in which the cutting edge 4 is provided by a small, detachable blade that is removably mounted on the shaft 3, and such a configuration could also be employed as a variation of the illustrated embodiment.

The handle 2 is elongate and provided with an internal cavity 21 of substantially uniform cross-section of hexagonal form, which can be seen in particular in the detail view of FIG. 3, taken along the section line 1A-1A.

The blade 3 is mainly of conventional chisel-shape, as shown particularly in FIG. 4. However, at its top (as seen in FIG. 4), the blade 3 is formed with a pair of shoulders 31 that lead to a narrow portion 32 of circular cross-section. At the top of the narrow section 32, an enlarged portion 33 flares outwardly to define an annular shoulder 34, followed by a further reduced shank portion 35 that is tapped to provide an external screw thread. A retaining cap 36 is provided at the end of the shank 35. This may be formed by peening over the end of the shank 35 or by attaching any suitable retaining member at the end of the shank—e.g. by way of a circlip engaging an annular groove at the end of the shank 35.

The shaft mounting assembly 5 comprises a blade holder 51 that is retained within an annular recess 22 provided at an open end of the handle 2. To this end, a circlip 59 engages an annular groove 23 formed in the wall of the annular recess 22 and abuts a flange 531 formed at a rear face 53 of the blade holder 51.

The blade holder 51 is formed with a slot 54, corresponding approximately in cross-sectional shape to the blade 3 dimensioned to allow passage of the blade 3 therethrough. The blade holder 51 has a front face 52 on which there are formed a pair of recesses 55 which are adapted to engage the shoulders 31 on the blade 3.

Mounted on the screw-threaded shank 35 of the blade 3 is a metal washer 58 of hexagonal shape and of a size to engage closely with the hexagonal walls of the handle cavity 21. The metal washer 58 abuts the annular shoulder 34 on the blade 3. A rubber washer 57 and then a steel nut 56 are located above the metal washer 58 (as seen in the figures), with the nut 56 in screw-threaded engagement with the shank 35. Both the metal nut 56 and the rubber washer 57 are of hexagonal cross-section, of a size to engage closely with the hexagonal walls of the handle cavity 21. The components 56 to 58 are retained on the shank 35 by way of the retaining cap 36

In use, the blade 3 may be adjusted between a first, working position as shown in views B and D of FIGS. 1 and 2 and a second, storage position, as shown in views A and C of FIGS. 1 and 2.

In order to bring the blade 3 from its storage position to its working position, it is allowed to slide out of the handle 2, through the slot 54 in the blade holder 51, until the shoulders 31 of the blade 3 are on the outside of the blade holder 51. The blade 3 is then twisted through substantially 90 degrees until the blade shoulders 31 register with the recesses 55 in the blade holder 51. Holding the blade 3 and the blade holder 51 with one hand, the handle 2 is then rotated clockwise with the other hand, thereby causing the entrained nut 56, rubber washer 57 and metal washer 58 to be rotated with respect to the longitudinal axis of the blade 3. As the nut 56 is in screw-threaded engagement with the shank 35 of the blade 3, the axial distance between the nut 56 and the blade tip 4 is progressively reduced, thereby bringing the blade shoulders 31 firmly into engagement with the mating recesses 55 on the blade holder 51. As the handle 2 continues to be turned, the retaining force that urges the blade shoulders 31 into engagement with the recesses 55 increases. Also, the axial force on the rubber washer 57 progressively increases and, as the washer is of rubber, it expands outwardly to jam firmly inside the handle cavity 21 by way of a radial force. It will be appreciated that sufficient force may quickly be applied to retain the blade 3 in its working position with the rubber washer 57 engaging firmly with the inner walls of the handle cavity 21. In this condition, there is a direct mechanical connection between the handle 2, blade holder 51 and blade 3, such that any impact force applied to the closed end of the handle 2 will be transmitted directly to the blade 3, in the manner of a conventional chisel.

When the user has finished with the chisel 1, the blade 3 can readily be stored again within the handle 2. To accomplish this, the blade 3 and blade holder 51 are again gripped in one hand and the handle 2 is rotated in a counter-clockwise direction by the other hand. This causes the nut 56 to travel up the threaded shank 35 (as seen in the figures), thereby releasing pressure between the blade shoulders 31 and their mating recesses 55 and, at the same time, releasing axial pressure on the rubber washer 57 and therefore its firm radial engagement with the inner walls of the handle cavity 21.

When the pressure has been sufficiently released, the user rotates the blade 3 again through 90 degrees, so that it is aligned with the slot 54 in the blade holder 51. Since the frictional engagement between the rubber washer 57 and the inner walls of the handle cavity has now been released, the blade 3 is free to drop back down inside the handle 2—for this purpose, the user may typically invert the handle 2 from its illustrated position.

When the blade 3 is in its fully retracted position, the tip end still engages within the slot 54, but is retracted below the front face 52 of the blade holder 51. The user once again holds the blade holder 51 in one hand and rotates the handle 2 clockwise with respect to the blade holder. Once again, this causes the nut 56 to travel along the threaded shank 35 and compress the rubber washer 57, which once again engages the inside walls of the handle cavity 21 in a frictional manner. Thus, the blade 3 is retained firmly within the handle 2 until it is next required for use. As will readily be appreciated, the blade 3 is once again freed by effecting mutual clockwise rotation between the handle 2 and the blade holder 51, to allow the blade 3 to slide out through the slot 54.

Thus, it will be appreciated that the illustrated embodiment of the invention provides a safety chisel 1 in which the blade 3 may readily be adjusted between an operational position in which it is ready for use in the manner of a conventional chisel, with forces being transmitted effectively between the handle 2 and the cutting edge 4, and a storage position in which the whole blade 3 with its cutting edge 4 is stored safely and securely within the handle 2. In the stored position, the blade 3 with its sharp edge 4 is stored safely out of harm's way, whether by way of accidental injury to a user or inquisitive third party, or by way of damage to the sharp edge 4. Thus, the chisel 3 may stay sharper and in much better condition for use for much longer. This provides particular advantages for craftsmen who typically work at different sites rather than at a permanent workshop, and in particular to craftsmen who use chisels as occasional tools rather than continuously—e.g. plumbers and electricians working on site, as opposed to cabinet makers working at their own workshop.

Carpenters typically carry chisels around in two ways. One is as a plastic sheath clipped to their tool belt; the other is in the pocket of their tool belt with a small plastic cover for the tip. The first option can be very awkward when climbing ladders or working on roofs or scaffolding. As there is nothing to hold the chisel in the sheath, it often drops out and then is a safety hazard. In the second option, the small plastic cover is lost very easily and the chisel is then not protected and also becomes a safety hazard.

At home, most DIY people have chisels where young children could have access to them and therefore they can again be a safety hazard.

Most plumbers and electricians do not have sharp chisels as the little plastic cover is soon lost and their chisels in their tool boxes soon become blunted because of other metal tools.

Of course, a further advantage of the illustrate chisel 1 is that, when the blade 3 is stored in the handle 2, the overall dimensions of the tool are very much less than those of a conventional chisel, with or without a removable blade.

It will be appreciated that various modifications may be made to the illustrated embodiment. Typically, chisel blades are made of metal but, with the advent of many sophisticated modern materials, they could be made of another suitable material that provides a sharp cutting edge, either directly or as a removable blade. The handle 2 may be of plastics or an alloy. The blade holder may be of steel or alloy. The rubber washer 57 may alternatively be made of any other suitable elastomeric material. The nut 56, washer 58 and circlip 59 may typically be made of steel, but any other suitable material may be employed.

As is evident from the foregoing, the illustrated chisel 1 is both quick and safe in operation, with little to go wrong and with parts that may be readily replaced.

FIG. 10 shows a tool belt attachment or pouch 12 in which three chisels 11, all of which may be constructed as described above, are held in respect pockets 13, which are open at top and bottom and in which the handles of the chisels 11 are firmly engaged, with the chisel blades safely stowed in the chisel handles. The pouch 12 has slots 14 to receive a tool belt (not shown), on which it may be carried. The three chisels may be of popular sizes—for example, of widths such as 6 mm, 12 mm and 25 mm (or ¼″, ½″ and 1″)—or of any desired sizes.

FIGS. 11 to 19 show an alternative safety chisel 100, in which a handle is formed of first and second handle parts 101 and 102, each of which is pivotally connected to a chisel blade 105 by respective pins (or rivets) 104 that engage in apertures 106 formed in the handle parts 101,102 and the chisel blade 105. The first handle part 101 is formed with a locating pin D and the second handle part 102 is formed with a corresponding locating hole F. A spring clip 103 is pivotally mounted on the first handle part 101 and is adapted to engage around the second handle part 102 to hold the two handle parts together, in both opened and closed positions. The first and second handle parts 101, 102 are each formed with a respective groove 107 which, when the chisel 100 is in the closed position, co-operate with one another to form a cavity 109 within which the chisel blade 105 is housed.

In FIG. 11, the chisel 100 is shown in an opened position. The two handle parts 101,102 are held together by the spring clip 103, with the chisel blade depending from the handle parts 101,102, to which the blade is secured by the pivot pins 104. In use, an impact force is applied to the top of the handle parts 101,102 which, as seen in FIG. 11, present a substantially flat impact surface. As shown in chain lines in FIG. 11, the lower parts of the handle parts 101,102 are formed with internal abutment faces 108 which abut an opposing face of the shaft of the blade 105, thereby to transmit impact forces to the chisel blade 105. This avoids the need to transmit the impact forces through the pins 104. To this end, there may be a small amount of play in the fixing provided by the pivot pins 104, such that impact forces are transmitted preferentially through the abutment faces 108 to the chisel blade 105.

In order to close the safety chisel 100, the spring clip 103 is released and the handle parts 101,102 are pivoted about their respective pins 104 until they are brought into the position illustrated in FIG. 12, where the spring clip 103 is again used to clip the two handle parts 101,102 firmly together. In the storage position of FIG. 12, the respective grooves 107 of the handle parts 101,102 form the cavity 109 in which the chisel blade 105 is safely stored, such that the sharp tip of the blade 105 is safely secured within the handle. In order to bring the safety chisel 100 once again into its working position, the above procedure is reversed to bring the handle parts 101,102 into their respective positions illustrated in FIG. 11. In this working position, the locating pin D on the first handle part 101 engages within the corresponding locating hole F on the second handle part 102, to provide positive location of the two handle parts.

The various parts of the safety chisel 100 are shown individually in FIGS. 13 and 16 to 19.

It may be appreciated that the safety chisel 100 illustrated in FIGS. 11 to 19 may be opened and closed in a particularly quick and efficient manner. In the storage position of FIG. 12, the chisel blade 105 is safely covered. The various parts of the safety chisel 100 may be manufactured and assembled in a simple and inexpensive manner. The handle parts 101,102 may be of any suitable material. The safety chisel 100 may be carried in a tool belt such as that illustrated in FIG. 10, for example.

It will be appreciated that the illustrated embodiments are conveniently described in their illustrated orientations, but may typically be used in any desired orientation. Therefore, words such as “top” and “above” are to be construed accordingly as not implying any absolute orientation.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A chisel comprising:
a handle;
an elongate shaft having a inner end and an outer end with a cutting edge at said outer end; and
mounting means for mounting the shaft on the handle:
wherein:
the handle has a cavity therein; and
the mounting means is arranged to mount the shaft in the handle in an adjustable manner such that, in a first, working position, the shaft extends from the handle and receives impact forces that are applied to the handle in use of the chisel; and, in a second, storage position, the shaft is stored within the cavity in the handle such that said cutting edge is not exposed.

2. A chisel according to claim 1, wherein said shaft is of metal.

3. A chisel according to claim 1, wherein said cutting edge is formed integrally with said shaft, at said outer end thereof.

4. A chisel according to claim 1, wherein said handle comprises wood.

5. A chisel according to claim 1, wherein said handle comprises metal or a plastics material.

6. A chisel according to claim 1, wherein said mounting means comprises a shaft holder at an open end of said cavity, said shaft holder having a slot that allows passage of said shaft therethrough and engagement means adapted to engage said shaft when in said first, working position, thereby to inhibit rotation of said shaft about its longitudinal axis.

7. A chisel according to claim 6, wherein said shaft has shoulders formed towards said inner end thereof and said engagement means on said shaft holder comprises recesses adapted to receive said shoulders.

8. A chisel according to claim 6, wherein said cutting edge is housed within said shaft holder when said shaft is in its second, storage position.

9. A chisel according to claim 1, wherein said mounting means comprises locking means provided within said cavity and arranged to lock said shaft in said first and second positions.

10. A chisel according to claim 9, wherein said locking means comprises at least one rotatable element carried on said shaft and arranged to be actuated by rotation of said handle with respect to said shaft.

11. A chisel according to claim 10, wherein said locking means comprises at least one nut member that screw-threadedly engages said shaft and is entrained by said handle for rotation with said handle.

12. A chisel according to claim 9, wherein said locking means comprises a resilient member that is arranged to be compressed, thereby to engage the walls of said cavity to inhibit longitudinal movement of said shaft.

13. A chisel according to claim 1, wherein said handle comprises first and second handle parts, each of which is pivotally mounted on said shaft for movement between open and closed positions such that, when said handle parts are in said open position, said shaft is in said working position and said handle parts cooperate to transmit impact forces to the shaft in use of the chisel and, when said handle parts are in said closed position, said shaft is in said storage position and said handle parts cooperate to define said cavity within which said shaft is stored.

14. A chisel according to claim 13, wherein said handle parts are mounted on said shaft by rivets or pins.

15. A chisel according to claim 13, wherein said handle parts define abutment faces which, when said handle parts are in said open position, abut an opposing face of said shaft, thereby to transmit impact forces to said shaft in use of the chisel.

16. A chisel according to claim 13, further comprising retaining means for retaining said handle parts in said open and closed positions.

17. A chisel according to claim 13 any of claims 13 to 16, further comprising location means for positively locating said handle parts in predetermined juxtaposition when in said open position.

18. (canceled)

19. A tool belt attachment comprising at least one pocket containing a chisel according to claim 1.

20. (canceled)
